(19) United States
(12) Patent Application Publication
(10) Pub. No.: US 2009/0274814 A1
(43) Pub. Date: Nov. 5, 2009

(54) Production method of meat substitute food substance

(76) Inventor: Miyuki Ishida, Kyoto-shi (JP)

Correspondence Address: JACOBSON HOLMAN PLLC, 400 SEVENTH STREET N.W., SUITE 600, WASHINGTON, DC, 20004, US

(21) Appl. No.: 12/219,033

(22) Filed: Jul. 15, 2008

(30) Foreign Application Priority Data
May 1, 2008 (JP) 119931/2008

(51) Int. Cl. A23L 1/0522

(52) U.S. Cl. 426/574

(57) ABSTRACT

Meat substitute food substance produced by melting the frozen konnyaku, pressing or compressing the molten konnyaku so as to dehydrate them and to obtain konnyaku chips containing a little volume of water, adding one or plural kinds of bonding materials to the konnyaku chips obtaining a mixture, crushing or cutting the chips and stirring them, adding one or plural kinds of non-water-soluble food of protein kind to the mixture and mixing the mixture in a mixing machine.

### BACKGROUND OF THE INVENTION

1. Field of the Invention

This invention relates to a production method of food substance, which substance substantially having a main material of devil's tongue jelly or konnyaku of a Japanese food, meal feeling and taste of meat, and being healthy. Additionally the meat substitute food substance produced by the production method of the present invention is able to eat after being cooked, and to add and mixed with other food materials before being cooked.

2. Description of the Prior art

Devil's tongue jelly or konnyaku has substantially no nutritive substance to be taken into a human body, resultantly it is said that konnyaku is healthy to a body because it discharges nutritive waste matter from a body after it is eaten. Konnyaku has a main substance of glucomannan, which is a kind of food fiber. Although glucomannan is a food fiber, it is not able to be resolved by means of digestion enzyme of human being. It has an effect of improving excrement discharge because it enters into the bowels before it is digested, absorbs water so as to be swelled and soften excrement during it moves within bowels. In addition to the fact above, konnyaku has low calorie, so that it is suitable to eat as a diet food. Glucomannan has effect of preventing blood sugar level from rising, and lowering cholesterol value, so that it improves diabetic trouble and high blood pressure disease. In recent years, konnnyaku has been widely used and ate, not only as a food stuff for ordinal cooking, but also a so-called healthy food of konnyaku jelly, konnyaku soup and the like.

The present invention provides a production method of healthy meat substitute food substance having a main material of konnyaku which konnnyaku being provided with excellent effect of health and having meat feeling and taste of meat, and low calorie. Conventionally, such meat substitute food product has not been used practically, and meat substitute food product produced from ordinal material of konnyaku provided with meal feeling and meat taste has not been marketed. When the past patent documents are retrospectively looked up, no preceding patent or technology concerning meat substitute food material is found. Only the Japanese invention shown in Japanese Patent Laid-open Official Gazette No 173,585/2004 describing a structure improving composition for meat food, which composition improving structure of meat food material, is publicly known.

As described above, it is noted that conventionally meat substitute food substance having a main material of konnyaku fails to be served practically. There has been a subject or problem that a meat substitute food substance made from konnyaku of healthy material has not been employed effectively to such food product.

The Japanese patent described in the Japanese Laid-open Official gazette above relates to a structure improving composition for meat food, which composition being dried and adapted to be added to processed foodstuff provided with original substance of meat and fish of jelled material, such as dried konnyaku process foodstuff, for example, hamburger, meat ball, sausage and the like in order to sustain any juicy meal feeling of fat and meat soup of the meat and fish thereof. The purpose of the structure improving composition is to be added to other processed foodstuff. There is no idea in the prior art of producing imitation food of, for example, so-called imitation fried chicken, imitation pork cutlet and imitation cattle meat. Consequently, the adaptation range of the prior art is restricted. And unfortunately the conventional structure improving composition has a subject or shortcoming of no elasticity similar to that of meat.

### SUMMARY OF THE INVENTION

The present invention has been accomplished so as to solve the object of the prior art and relates to meat substitute food substance provided with a main material of konnyaku and no meat material, and bonding material, non-water-soluble foodstuff of protein type, and if necessary meat extract and spice.

The first object of the present invention is to provide a production method of a meat substitute food substance from no meat completely, which substance having meal feeling, taste of meat and low calorie, excellent characters of diet food and health.

The second object of the present invention is to provide a production method of a meat substitute food substance, which is produced very easily by a food product manufacturing companies and cooked easily by any person after it is bought from a market.

The third object of the present invention is to provide a production method of a meat substitute food substance which can be employed to produce an imitation food similar to the food produced from meat usually and originally, such as fried chicken imitation food, pork cutlet imitation food, meat imitation food, and hamburger imitation food.

The fourth object of the present invention is to provide a production method of a meat substitute food substance by means of adding and mixing a suitable volume of it to minced cattle meat, pork meat, chicken meat so as to manufacture hamburger, meat ball, gyoza or wrapped meat and vegetables of Chinese style, croquette, hamburger steak and the like, enabling to reduce the meat volume to be used.

The objects above and other objects of the present invention and novel characteristics thereof will be more apparent from the following detailed explanation. However, the detailed explanation fails to restrict the scope of the present invention.

### DETAILED EXPLANATION OF THE INVENTION

The best embodiments of the present invention will be described in detail. The present invention relates to a production method for producing a meat substitute food substance having a main material of konnnyaku, which was prepared by dissolving or melting the frozen konnyaku and having no meat, by means of adding bonding material, such as egg, wheat flour, non-water-soluble food of protein kind and, if necessary, cattle meat extract and spice so as to provide meat meal feeling and taste. It is noted that in the specification of the present invention “meat” means cattle meat, and doesn't mean fish meat.

Konnyaku, which is made by pealing the skin of the konnnyaku potato and crushing the potato is named a white konnyaku, and another konnyaku, which is made using konnyaku potato powder with skin of the devil's tongue jelly is named a black konnyaku. Konnyaku in a plate or board shape is called a plate konnyaku and that in thread shape is a thread konnyaku. These various kinds and shapes of konnyaku described above are all able to be employed in the production method of meat substitute food substance of the present invention.

The white konnyaku, black one, and thread one above are respectively employed in the various embodiments described below in accordance with the various usages of the embodiments. In the embodiments, the konnnyaku is frozen in a freezer and the frozen one is used. The reason why frozen konnnyaku is used is that almost all the content of water contained in konnyaku will be dehydrated or decreased at its level by means of freezing the konnyaku, melting it and then pressing or compressing it. Thus, pieces of konnyaku having low water content and food fiber occupying almost all space in the konnyaku are obtained. The konnyaku pieces are called a konnyaku block. The food fiber in the konnyaku blocks makes the konnyaku of meat substitute food substance resilient or elastic. In accordance with the present invention, meat food feeling and meat food taste of meat substitute food of konnyaku attained by elastic fiber material contained in the konnyaku.

The bonding or connecting materials of the other materials are used to connect the molecules of the non-sticky food substance of the present invention to each-other in order to prevent the molecules of the material of food substance from being separated from each other and lumps of the food substance from being broken.

Bonding or connection material, which is able to be used or employed in meat substitute food substance of the present invention are described below. For example, egg, yolk, albumen, egg powder, wheat flour or powder, buckwheat powder, rye powder, barley powder, corn flour, bread powder, rice powder, soybean powder, and the like are used as a bonding material in the production method of the present invention. Other raw materials of grain flour to be used in the production method of the invention are wheat flour, corn starch, rice cake kind corn starch, tapioca starch, rice starch, sweet potato starch, and arrowroot starch. Other material which are obtained by alpha-charging and ethyl-charging process for these starches, acetic acid ester, processed starch bridged or oxidized treated chemical processed starch, Arabia gum, algine acid, pectin, thyrium seed gum, crystal cellulose, carboxyl methyl cellulose, methyl cellulose, bengal gelatin, gelatin, wheat gluten, soybean gluten, tofu waste dried powder, yam, collagen, and gelatin powder.

It is not necessary to select and specify the bonding material to be used in the production method of the meat substitute food substance of the present invention one or plurality of these bonding materials mentioned above. Preferably, it is recommended that albumen, egg, collagen, or wheat flour are used. Also, it is possible to employ if necessary a plurality of kinds of bonding material in combination.

Furthermore, non-water-soluble food of protein described above are fu of a light cake of wheat gluten and koya tofu which is made of freezing and drying tofu, tofu waste and tofu itself containing much water of protein kind. In the production method of the present invention, fu and koya tofu of dried and non-water-soluble food are used. They are used after a process or steps of powdering, chipping or crushing them to make flake shape of the fu and koya tofu. Tofu waste and tofu contain much water and they are used as they are. Wheat flour is able to be used as the bonding material above or as non-water-soluble food of protein.

The protein component of non-water-soluble food is taken into and between a number of small chips of konnyaku, entangled with such small chips, resulting in a suitable degree of elasticity of the konnyaku similar to that of meat and meal feeling and meat taste which are obtained therein. It is not necessary to restrict one kind of non-water-soluble food to be used in the production method of the present invention and, however, if necessary, it is possible to use a plurality of kinds of the non-water-soluble food in combination in the production method of the present invention.

That is, in accordance with the present invention, an effect of meat fiber portion and meat protein portion is substitutionally obtained by taking or inserting protein composition between a number of chips of konnyaku block in order to make them tangled with each other.

Additionally, cattle meat extract contained in the bonding material is used as a meat imitation giving material in the meat substitute food substance of the present invention, because these bonding materials above have substantially no taste. The cattle meat extract is made by concentrating the extract of the meat so as to obtain liquid, powder or solid shaped materials. It seems not necessary to restrict specifically the kind of extract, however, it is recommended to use a taste extract powder or beef extract powder. These cattle meat extract is used only when it is necessary to produce the meat substitute food substance. Also, spice is used optionally in the production method of the present invention.

Next, the production steps of meat substitute food substance employing and handling various materials so as to attain the objects and effects of the present invention will be explained. These materials and combination ratio of them are determined in accordance with the test result of experiments carried out according to the production method of the present invention.

First, konnyaku frozen in a freezer for one day or more than one is melted by a natural way of room temperature or compulsory way such as one of heating and cooking using an electronic range and the like. Next, the melted konnyaku is washed with water, dehydrated by pressing or compressing to get out of almost all water content from the konnyaku resultantly, konnyaku pieces containing small volume of water, such as 5-15 weight % is obtained. The almost all volume of konnyaku is made eatable fiber. According to the experimental result, the konnyaku which has originally a weight of 500 g, melted and dehydrated, becoming its weight of about 60-150 g and its water content of 5-15 weight %. In the embodiments of the meat substitute food substance production method of the present invention, any konnyaku mentioned above can be used and the konnyaku chips containing the water content of 5-15 weight % is preferably used.

In accordance with the present invention, konnyaku chips preferably having a shape of dice, 40-80 weight %, preferably 55-75 weight %, more preferably 65-70 weight %, bonding material, for example, egg (only albumen is healthy for persons having a high cholesterol level, and egg can be used for all other persons in healthy manner) of 5-40 weight %, preferably 10-25 weight %, more preferably 15-30 weight % are placed into a mixing machine or blender in order to cut them to more small chips and then the konnyaku chips are mixed with the bonding material attaining a mixture of them. The mixture finally has a condition of paste. The following explanation of the production method for meat substitute food substance will be done on embodiments of the present invention, in which embodiments a boding material of egg is employed.

When konnyaku chips of dice shape and bonding material of egg are charged in a cutting and mixing machine, it is necessary to prevent the konnyaku chips from being crushed finely. It is recommended and not to restrict the scope of the present invention to cut the konnyaku chips into small pieces of size of about 1-10 mm. When the konnyaku chips and bonding material of egg are charged in the cutting and mixing machine, a mixture of them is obtained. It is necessary to make these konnnyaku chips contain water content of abut 5-15 weight % in order to make the mixing and stirring function of such konnyaku chips and bonding egg swift and effective, and make the crushing and cutting operation of these chips easy.

The mixture of cut konnyaku chips and bonding egg is taken out of the cutting and mixing machine. The non-water-soluble food of one kind of protein or non-water-soluble food of plural kinds of protein of 2-30 weight %, preferably 4-25 weight %, more preferable 5-20 weight % is added to the mixture. Furthermore, if necessary, a little volume of salt, pepper, garlic and other spices are added and they are mixed in the mixing machine, resultantly in obtaining of meat substitute food substance of the present invention. The final condition of the meat substitute food substance produced by the production method of the present invention is paste.

For example, fu or koya tofu, which are non-water-soluble dried food of protein, in shape of powder or flake, and of tofu waste or tofu itself of non-water-soluble food of protein and having a high water content are added to and mixed with the mixture.

When a meat-like taste is necessary to the meat substitute food substance of the present invention, 0.5-3 weight %, preferably 0.7-2.5 weight %, more preferably 1-2 weight % of a cattle meat extract selected from, for example, a group of consomme or beef extract is added and they are mixed.

By means of cutting the konnyaku chips by a cutting and mixing machine obtaining small pieces of a length of about 1-10 mm of the chips, it makes possible to take protein component of the non-water-soluble food within a number of fine pieces of konnyaku. The protein component and fine pieces of konnyaku are tangled with each other and meat like elasticity is attained in the meat substitute food substance of the present invention.

According to the production method for the meat substitute food substance of the present invention described above, first the konnyaku chips and bonding material are crushed or cut, then mixed and stirred in a cutting and mixing machine, and non-water-soluble food of protein is added to the mixture and it is stirred. In accordance with one of other production method of meat substitute food substance of the present invention, first only konnnyaku chips are cut in the cutting and mixing machine, the non-water-soluble food of protein, if necessary, cattle meat extract and bonding material are added to the konnyaku chips. These materials are charged into a stirrer machine obtaining meat substitute food substance of paste condition.

To the meat substitute food substance of paste condition which substance is produced by the production method of the present invention, other food substances are added. Such meat substitute food as fried chicken substitute food, pork cutlet substitute food, and cow meat substitute food are produced by the production method of the present invention. These meat substitute food has no meat, so that resulting in a low calorie and healthy characters effecting for men.

Furthermore, it is possible to add the meat substitute food substance produced according to the present invention to raw material of hamburger, meat ball, gyoza or Chinese style wrapped meat and vegetables, croquette, hamburger, and mix them resultantly increasing the volume of the food product. The food product mentioned above is not the meat imitation food.

By means of adding a suitable volume of meat substitute food substance produced by the production method of the present invention to raw or pure material of hamburger and mix them each other, it is possible to produce the food product of low calorie relative to the final weight or volume of the product because the meat substitute food substance of the present invention fails to contain any meat.

Various embodiments of the production method of the meat substitute food substance of the present invention and the meat substitute food product produced by adding a number of food materials to the meat substitute food substance of the present invention, and cooking the mixture will be explained.

### First Embodiment

Production of Fried Meat Imitation Food (Fried Chicken Substitute Food)

(a) In case of using powder gluten

<material>

| | |
|---|---|
| White plate konnyaku pieces, which is almost all water | 80 weight % |
| is dehydrated. | |
| Albumen | 10 weight % |
| (For person who doesn't have troublesome | |
| cholesterol. Egg 10 weight %). | |
| Powder gluten | 5 weight % |
| Wheat flour | 5 weight % |
| Chicken soup extract powder (in case of necessary) | a little |
| Salt pepper (in case of necessary) | a little |
| The above is the material for fried chicken imitation food | |
| which uses powder gluten. | |
| The following materials are added. | |
| Coating powder | suitable volume |
| Oil | |

(b ) In case of using tofu waste

<material>

| | |
|---|---|
| White plate konnyaku pieces which is almost all water | 60 weight % |
| is dehydrated therefrom is used. | |
| Albumen | 15 weight % |
| (for the person who doesn't care of cholesterol or | |
| doesn't have troublesome cholesterol. | |
| Egg 15 weight %) | |
| Tofu waste | 21.5 weight % |
| Wheat flour | 3 weight % |
| Salt pepper (in case of necessary) | a little |
| The above is the material used to fried chicken | |
| imitation food which used tofu waste. | |
| The following materials are used. | |
| Coating powder | suitable volume |
| Oil | |

The production method of fried chicken imitation food using the materials of (a)-(b) above.
(1) Melt the white plate konnyaku frozen for one day or more.
(2) Rightly wash the melted white plate konnyaku, press or compress the konnyaku, and dehydrate sufficiently making konnyaku block.
(3) Cut the konnyaku blocks into that of a shape of dice.
(4) Put the konnyaku dices and egg into a mixer making them of fine size, and sufficiently mix and stir them.
(5) Take out the stirred matter, place it into different vessel, add either one of powder gluten, tofu waste and wheat flour, and if necessary chicken soup extract powder, mix and stir them making fried chicken imitation food product. (if necessary, salt and pepper are added too)
(6) Divide the fried chicken imitation food product produced according to (5 ) into that of smallest size, place coating on the smallest product balls and fried the with oil obtaining the finished one.

### Second Embodiment

Production Method of Pork Cutlet Imitation Food (Pork Substitute Food)

(a) In case of using fu

<material>

| | |
|---|---|
| White plate konnyaku pieces dehydrated | 70 weight % |
| almost all water therein. | |
| Fu (powdered or in a shape of flake) | 3 weight % |
| Wheat flour | 5 weight % |
| Beef extract powder | 2 weight % |
| Albumen | 20 weight % |
| Garlic, salt and pepper | each a little |

The above are pork cutlet imitation food substance or product. Furthermore, the following are added.
Sliced cheese
Flying oil

(b) In case of using tofu waste

<material>

| | |
|---|---|
| White plate konnyaku pieces dehydrated almost all water. | 57 weight % |
| Tofu waste | 25 weight % |
| Wheat flour | 5 weight % |
| Beef extract powder | 3 weight % |
| Egg | 10 weight % |
| Garlic, salt and pepper | each a little |

The above are pork cutlet imitation food substance using tofu waste. Furthermore the following are added.
Sliced cheese
Bread powder
Flying oil

Production method of pork cutlet imitation food using the material of (a)-(b) above.
(1) Cut white plate konnyaku chips to one of suitable size and freeze them. (Preferably, slice them so that it is easily dehydrated resultantly in goods of nice tasty food)
(2) Melt the white plate konnyaku after it has been frozen for one day or more days.
(3) Defreeze the dehydrated white plate konnyaku with water, press or compress it in order to sufficiently dehydrate it making it of small chips.
(4) Cut the konnyaku chips to dice size and shape one.
(5) Put them into a mixer together with egg in order to make konnyaku chips of more small, and sufficiently blend and stir them.
(6) Take out the mixed and stirred material from the mixer and transfer it to other mixer. Put fu or tofu waste, wheat flour or powder, beef extract powder, garlic, salt and pepper into the mixer in order to sufficiently blend and stir them making pork cutlet imitation food substance.
(7) Divide the sliced cheese in half and wrap the halved cheese slice with the pork cutlet imitation food substance made according to (6) above making it of a sandwich shape.
(8) Then, in accordance with the regular process of ordinal or conventional pork cutlet product, wrap or coat the sandwich of the substance with wheat flour, stir egg and, bread powder, fry it in oil finally.

### Third Embodiment

Production of Meat Imitation Food (Meat Substitute Food)

(a) In case of using fu

<material>

| | |
|---|---|
| Black plate konnyaku piece dehydrated | 75 weight % |
| almost all water | |
| Fu (powdered or flaked) | 4 weight % |
| Albumen | 15 weight % |
| Wheat flour | 5 weight % |
| Beef extract powder | 1 weight % |
| Garlic, salt, pepper | each a little |

The above material is for meat substitute food substance using fu.

(b) In case of using tofu waste

<material>

| | |
|---|---|
| Black plate konnyaku piece dehydrated | 60 weight % |
| almost all water | |
| Tofu waste | 25 weight % |
| Egg | 10 weight % |
| Wheat flour | 3 weight % |
| Beef extract powder | 2 weight % |
| Garlic, salt, pepper | a little |

The above are for meat substitute food substance using tofu waste.

Production method of meat substitute food substance using the materials of (a)-(b) above.

The production steps of (1)-(6) above are the same as these of the embodiment 2 producing the meat substitute food substance of the present invention.
(7) Spill the meat substitute food flatly on a flying pan in a similar way of production steps and bake the thin crapes,
(8) After they are sufficiently baked tear the food substance so as to obtain cattle meat shape.
(9) Finally, fry vegetables in a frying pan, put the torn substance of (8) into the vegetables, and season them. It is recommended that volume of seasoning powder is rather small.

### Fourth Embodiment

Production Method of Hamburger Imitation Food (Beef Substitute Food)

(a) In case of using koya tofu

<material>

| | |
|---|---|
| Black plate konnyaku dehydrated almost all water. | 65 weight % |
| Koya tofu (powdered or flaked). | 10 weight % |
| Albumen | 15 weight % |
| Wheat flour | 5 weight % |
| Bread powder | 2 weight % |
| Beef extract powder | 1 weight % |
| Onion (chopped) | 2 weight % |
| Garlic, salt, pepper | each a little |
| Nutmeg | suitable volume |

The above is for the hamburger imitation food substance using koya tofu.

(b) In case of using tofu waste

<material>

| | |
|---|---|
| Black plate konnyaku pieces dehydrated | 60 weight % |
| almost all water content. | |
| Tofu waste | 20 weight % |
| Egg | 10 weight % |
| Wheat flour | 5 weight % |
| Bread powder | 2 weight % |
| Beef extract powder | 1 weight % |
| Onion (chopped) | 2 weight % |
| Garlic, salt, pepper | each a little |
| Nutmeg | suitable volume |

The above materials are prepared for making hamburger imitation food substance using tofu waste.

Production method of hamburger imitation food using the above (a)-(b) material.

(1)-(6) steps are the same as that of the embodiment 2 producing hamburger imitation food substance of the present invention.
(7) Then, separate a suitable volume of the hamburger imitation food substance, form it in a hamburger shape, and then it is baked on flying pan in an ordinal way of hamburger product.

In accordance with these embodiments of the present invention, koya tofu, fu and tofu waste are used as non-water-soluble food of protein kind. It is possible to employ additionally collagen and regular tofu of non-water-soluble food of protein kind, other than koya tofu, fu, and tofu waste, in order to raise a content volume of protein contained in the meat imitation food product.

In accordance with the present invention, the meat substitute food substance produced by the production method is added at a rate 20-80 weight %, preferably 30-70 weight %, more preferably 40-60 weight % to chicken, pork and cattle meat in a minced condition in order to manufacture hamburger meat ball, gyoza or Chinese wrapped meat and vegetables, croquette and hamburger. As to the taste of these foods, the taste of them is not inferior than that of the hamburger, meat ball, gyoza, croquette, hamburger, respectively of ordinal type and using meat. It is apparent that thee meat substitute food products use meat of smaller volume than that of the regular meat product, so that the meat food product produced in accordance with the present invention is useful in particular as diet food.

It is possible to sell the meat substitute food substance of the present invention in a paste condition, and/or freeze and dry the paste substance. Consequently, the frozen and dried meat substitute food substance produced by the production method of the present invention is able to be preserved for a long time obtaining a merit of the sale or marketing effect of the product.

The meat substitute food substance produced by the method of the present invention doesn't use any meat, because the main material of the substance is konnnyaku. Bonding material, non-water-soluble food of protein, and if necessary cattle meat extract and spices are added to the meat substitute food substance having meat meal feeling and meat taste and low calorie, so that it is suitable to make a diet food or healthy food. Meat meal chewing feeling and meat taste are obtained is the meat substitute food substance of the present invention by placing the protein component of non-water-soluble food fiber of konnyaku and they are tangled.

The meat substitute food substance produced by the production method of the present invention is able to be produced very easily by food making companies and any person bought the meat substitute food substrate product can cook it very easily.

Furthermore, using of the meat substitute food substance is able to produce, so-called imitation food, such as chicken imitation food, pork cutlet imitation food, meat imitation food and hamburger imitation food.

Additionally, it is noted that when a suitable volume of the meat substitute food substance produced according to the present invention is added to meat of cattle meat, pork and chicken, producing hamburger, meat ball, gyoza, croquette and hamburger, it is said that the meat imitation food is not inferior than the meat food product using only real meat in taste. Furthermore, less volume of meat is used in a production of the meat substitute food substance of the present invention, resultantly the food substitute food is useful economically and effective as a diet food.

What is claimed is:

1. A production method of a meat substitute food substance, comprising the steps of melting the frozen konnyaku, press or compress the molten konnyku in order to dehydrate almost all water contained in the konnyaku resulting in konnyaku chips containing a little water, add one or plural kinds of bonding materials to the konnyaku chips, crush or cut finely the konnyaku chips and mix the konnyaku chips and the bonding material by a cutting and mixing machine obtaining a mixture, add one or plural kinds of non-water-soluble protein food to the mixture, and mix and stir them by a mixer.

2. A production method of a meat substitute food substance, comprising the steps of melting the frozen konnyaku, press or compress the molten konnyku in order to dehydrate almost all water contained in the konnyaku resulting in a konnyaku chips containing a little water, add one or plural kinds of bonding material to the konnyaku chips, crush or cut finely the konnyaku chips and mix the konnyaku chips and the bonding material by a cutting and mixing machine obtaining a mixture, add one or plural kinds of non-water-soluble protein food and cattle meat extract to the mixture, and mix and stir them by a mixer.

3. A production method of meat substitute food substance, comprising the steps of defreezing frozen konnyaku, press or compress the molten konnyaku in order to dehydrate almost all water contained in the konnyaku, resulting in a konyaku chip containing a little water, crush or cut finely the konnnyaku chips by means of a cutter, add one or plural kinds of bonding materials and one or plural kinds of no-water-soluble protein food, and mix and stir them by means of a mixing and stirring machine.

4. A production method of meat substitute food substance, comprising the steps of melting the frozen konnyaku, press or compress the molten konnnyaku in order to dehydrate almost all water existed in the konnyaku, resulting in a konnyaku chip containing a little water, crush or cut finely the konnyaku chips, add one or plural kinds of bonding materials, one or plural kinds of non-water-soluble protein food, and cattle meat extract, and mix and stir the mixture.
